(19) United States
(12) Patent Application Publication
(10) Pub. No.: US 2014/0364216 A1
(43) Pub. Date: Dec. 11, 2014

(54) METHOD OF USING GRAPHICAL COMPUTER READABLE CODES IN A GAMING ENVIRONMENT AND SYSTEM THEREWITH

(71) Applicants: Gerald Duhamel, Drummondville (CA); Mike Macke, Duluth, GA (US); Marc Nizdil, Duluth, GA (US)

(72) Inventors: Gerald Duhamel, Drummondville (CA); Mike Macke, Duluth, GA (US); Marc Nizdil, Duluth, GA (US)

(21) Appl. No.: 14/297,908

(22) Filed: Jun. 6, 2014

Related U.S. Application Data
(60) Provisional application No. 61/832,764, filed on Jun. 7, 2013.
(60) Provisional application No. 61/900,893, filed on Nov. 6, 2013.

(51) Int. Cl. G07F 17/32

(52) U.S. Cl. CPC G07F 17/3211
USPC 463/31

(57) ABSTRACT

The present document describes a method of using a graphical computer readable code in a gaming environment comprising a gaming device. The method comprises: gathering gaming information; gathering ID data about a recipient, namely recipient ID data, to whom the gaming information is intended; generating the graphical computer readable code, such that it comprises the gathered gaming information; displaying the graphical computer readable code; and, in response to a scanning of the graphical computer readable code, communicating the gathered gaming information to the recipient using the recipient ID data.

### CROSS-REFERENCE TO RELATED APPLICATIONS

This application claims priority of U.S. provisional patent application 61/832,764 filed Jun. 7, 2013, and U.S. provisional patent application 61/900,893 filed Nov. 6, 2013, the specifications of which are hereby incorporated by reference.

### BACKGROUND

(a) Field

The present description relates to a method of using graphical computer readable codes in a gaming environment and the system associated therewith.

(b) Related Prior Art

The gaming industry has evolved a lot since the first mechanical slot machines; most of the gaming devices are now advanced electronic machines, but the communication with gaming authorities, patrons and third-parties is often difficult and ridden with entry errors and other obstacles.

Improvements in this field are desired to facilitate, enhance, enrich and in any way make better, faster, and safer the interactions and communications between parties being part of the industry, such as the game manufacturers, the gaming authorities, the gaming facilities operators, and the players.

### SUMMARY

According to an embodiment, there is provided a method of using a graphical computer readable code in a gaming environment comprising a gaming device, the method comprising: gathering, on the gaming device, gaming information; gathering, on the gaming device, ID data about a recipient, namely recipient ID data, to whom the gaming information is intended; generating, on the gaming device, the graphical computer readable code, such that it comprises the gathered gaming information; displaying, on the gaming device, the graphical computer readable code; and in response to a scanning of the graphical computer readable code using a code scanning device, communicating the gathered gaming information to the recipient using the recipient ID data.

According to an aspect, the method further comprises gathering, on the gaming device, date and time information; and wherein the graphical computer readable code comprises the date and time information.

According to an aspect, the gathered gaming information comprises at least one of: (a) device identification information; (b) device status information; and (c) game status information.

According to an aspect, the recipient comprises at least one of (a) gaming authorities; (b) a gaming facility operator; (c) a game operator; (d) a game manufacturer; and (e) a game player.

According to an aspect, the graphical computer readable code comprises a one- or two-dimension barcode.

According to an embodiment, there is provided a method of using a graphical readable code in a gaming environment comprising a gaming device, the method comprising: gathering, on the gaming device, gaming device information comprising: information for identifying the gaming device, namely device identification information; and information about a status of the gaming device, namely device status information; gathering, on the gaming device, ID data about a recipient, namely recipient ID data, to whom the gaming device information is intended; generating, on the gaming device, a graphical computer readable code comprising the gaming device information and the recipient ID data; displaying, on the gaming device, the graphical computer readable code; and in response to a scanning of the graphical computer readable code using a code scanning device, communicating the gaming device information to the recipient using the recipient ID data.

According to an aspect, the steps of gathering the gaming device information, gathering ID data about the recipient, generating the graphical computer readable code and displaying the graphical computer readable code are realised only upon request.

According to an aspect, the method further comprises gathering, on the gaming device, date and time information; and wherein the graphical computer readable code comprises the date and time information.

According to an aspect, the recipient comprises at least one of (a) gaming authorities; (b) a gaming facility operator; (c) a game operator; (d) a game manufacturer; and (e) a game player.

According to an aspect, the graphical readable code comprises a one- or two-dimension barcode.

According to an embodiment, there is provided a method of using a graphical readable code in a gaming environment comprising a gaming device, the method comprising: gathering, on the gaming device, game status information; gathering, on the gaming device, ID data about a recipient, namely recipient ID data, to whom the game status information is intended; generating, on the gaming device, a graphical computer readable code comprising the game status information and the recipient ID data; displaying, on the gaming device, the graphical computer readable code; and in response to a scanning of the graphical computer readable code using a code scanning device, communicating the game status information to the recipient using the recipient ID data.

According to an aspect, the steps of gathering the game status information, gathering ID data about the recipient, generating the graphical computer readable code and displaying the graphical computer readable code are realised only upon request.

According to an aspect, the method further comprises gathering, on the gaming device, date and time information; and wherein the graphical computer readable code comprises the date and time information.

According to an aspect, the recipient comprises at least one of (a) gaming authorities; (b) a gaming facility operator; (c) a game operator; (d) a game manufacturer; and (e) a game player.

According to an aspect, the graphical readable code comprises one- or two-dimension barcode.

Within the present document, embodiments fulfilling the present objects are provided in relation with different gaming environments.

### DEFINITIONS

In this specification, the terms “graphical computer readable codes” refer to one- or two-dimension barcodes that contain machine-readable information and that are printed on an object or product, or displayed on a screen. They comprise one-dimension barcodes, presenting themselves as a series of parallel lines varying in widths and spacings, usually printed in a single color contrasting to the background; as well as two-dimensional barcodes such as Aztec or QR codes. The Aztec code is built on a square grid with a bulls-eye pattern at its center, wherein data is encoded in a concentric manner around the central patter. A QR code consists in square dots arranged in a square grid usually printed in a single color contrasting to its background, often black on white, with standard reference markers. Naturally, these terms may also comprise any form of existing or future, public or proprietary, barcode. Any graphical computer readable code herein described may be read by an imaging device (a camera for example) and processed to obtain the information it contains or to which it refers. These terms may be replaced in the current description by the term “barcode” to refer to the same concepts.

The terms “gaming device” comprise any device, being electronic or not, allowing Patrons to play a game in exchange of coins, tokens, tickets or credits and providing a score or a payout in points, credits or money to evaluate the success of the player in the game. The points or credits may be exchanged for further plays in this or another game, for material articles (such as dolls, toys or novelty articles), or money. The score or payout may be based on skill (such as trivia, a memory game, or a physical skill game), or on chance (such as pachinko, lotto or a line game).

The terms “gaming information” refers to any information which can be of interest to a person (aka a recipient) associated to a gaming device. Examples include, but are not limited to, the gaming device (ID code, software or hardware information, IP address if connected to the internet, etc.), the location where the gaming device is installed or its owner/manager (ID data, address, name(s) of owner(s)/manager(s), security level, etc.), the game played on the gaming device (title, type of game, value of a jackpot when offered, play ID, outcome of a play, etc.), gaming authorities, or a patron (ID data, credits, category of patron, security level, wins, losses, realisations, etc.).

The terms “gaming facilities” comprise any place wherein gaming is offered. The gaming facility may be dedicated to the gaming activities, such as a casino or a redemption center, or gaming activities may be offered along with other activities, such as in a restaurant or a bar. Also, the gaming facility may be permanent, or temporary such as in country fairs and seasonal locations. These terms may be replaced in the current description by the term “location” to refer to the same concepts.

The terms “gaming mobile application” describes an application installed on a mobile device, such as a smart phone or a tablet, usually equipped with scanning equipment able to scan barcodes (usually the camera component of the mobile device). The gaming mobile application usually helps users to interface with a gaming provider website, the barcodes allowing them to identify themselves and providing access to their level of access depending on permissions.

The terms “gaming provider website” describe a site allowing users to gain access to or procure at least one of: (a) useful information, (b) gaming device activation procedures, (c) products, (d) gaming participations, (e) promotions, (f) entries in a drawing or a sweepstake, and (g) rewards or trophies.

The term “sweepstake” describes a legal contest or game of chance wherein entries may be obtained through a [symbol] no purchase necessary [symbol] method or are offered with the purchase of a product. This kind of contest is well-known and has been around for some time, often associated to consumable products (such as soft drinks or snack food). The product may also be intangible, such as internet access minutes, long-distance call minutes or gift certificates. Regardless of the nature of the product, when a sweepstake is in place, for each product purchase, patrons receive sweepstake entries. Usually, the outcome of a sweepstake entry may be revealed immediately upon reception.

The terms “sweepstake entry” describes an entry or participation in a sweepstake game, and which is defined, in advance, according to a pay table. The pay table predetermines the number of entries, the proportion of winning entries, and for each winning entry, the prize that it awards. A new sweepstake entry set is generated for each sweepstake game. The outcome of each sweepstake entry (whether an entry is winning, and if so, its associated prize) is hidden and needs an intervention to be revealed. In some cases, the intervention is human, such as scratching a painted surface or opening a window, or, as is the case with electronically-operated sweepstake, an electronic device capable of reading the code of each sweepstake entry intervenes to reveal the outcome. The entries are of two types: purchase entry, which are given to a person for having purchased a product and no-purchase entry which are free and may usually be obtained directly from the sweepstake operator. The products may be tangible such as food or merchandise, or intangible such as gift certificates or long-distance call minutes.

The terms “entertaining reveal game” describe an entertaining animation in the format of a game where the result of the game is predetermined by the outcome of one or a plurality of sweepstake entries. In other words, the entertaining reveal game is a more amusing way to reveal and display the outcome of sweepstake entries to the player, than a simple “You won $##.##” or “Better chance next time”. The game could be as simple as a scratch ticket or a line-game-like animation wherein each play is the reveal of the outcome of one sweepstake entry. But it may also be as complex as a multi-step adventure game where the story reveals, as it unfolds, the outcomes of a plurality of sweepstake entries.

The terms “redemption gaming” describe a gaming activity that rewards players proportionally to their score in the game, usually in the form of tickets redeemable against a prize. In most jurisdictions, this prize is non-monetary, such as toys, gadgets and apparels, but may also comprise gift certificates and gift cards.

### BRIEF DESCRIPTION OF THE DRAWINGS

Further features and advantages of the present disclosure will become apparent from the following detailed description, taken in combination with the appended drawings, in which:

FIG. 1 is a schematic diagram which describes a simple embodiment of a method of using a graphical computer readable code in a gaming environment;

FIG. 2 is a schematic diagram showing a perspective view of a gaming machine according to an embodiment;

FIG. 3 is a schematic diagram which illustrates an embodiment of the relationship between the components of the sweepstake system;

FIG. 4 is a schematic diagram which illustrates an embodiment of the relationship between the components of the sweepstake system when a Point of Sale (POS) is present;

FIG. 5 is a schematic diagram which describes the activation of a sweepstake validator or of a POS in a sweepstake embodiment;

FIG. 6 is a schematic diagram which describes how to fill or refill the product inventory in a sweepstake embodiment;

FIG. 7 is a schematic diagram which illustrates an embodiment of the method of providing a sweepstake game;

FIG. 8 is a schematic diagram which illustrates an embodiment of the method of providing a sweepstake game when a POS is present; and

FIG. 9 is a schematic diagram which illustrates an embodiment of the method of using a graphical computer readable code in a gaming environment where the status of the gaming device is gathered.

It will be noted that throughout the appended drawings, like features are identified by like reference numerals.

### DETAILED DESCRIPTION

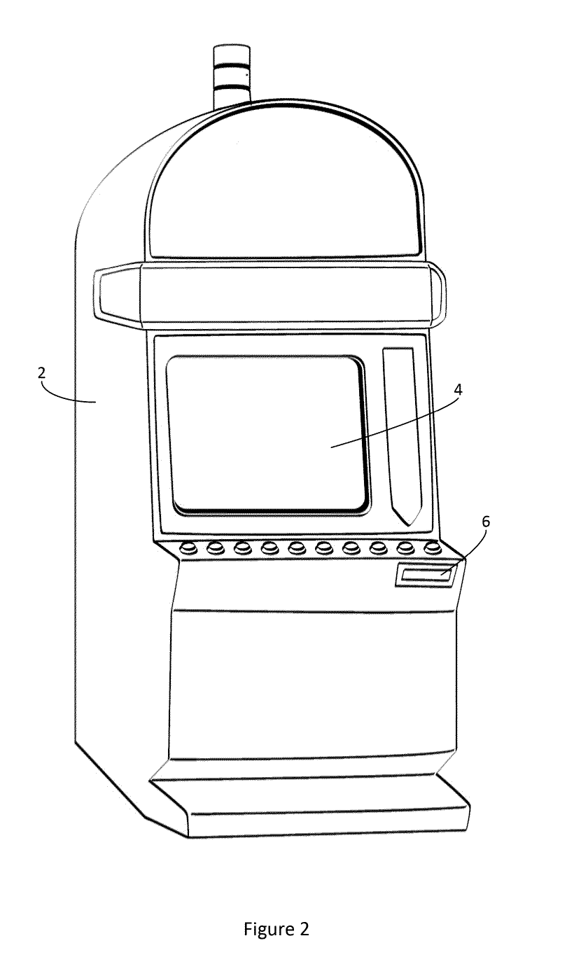

Embodiments of the presently described methods and systems may be carried out using a gaming device, such as a personal computer, a gaming terminal, a server or a gaming machine as illustrated in FIG. 2. The gaming device may comprise a cabinet 2, on which a barcode, printed on a sticker or a banner, could be attached, a screen 4 on which the barcode could be displayed, a printer 6 capable of printing tickets and coupons bearing barcodes, and a camera (not shown), capable of scanning barcodes.

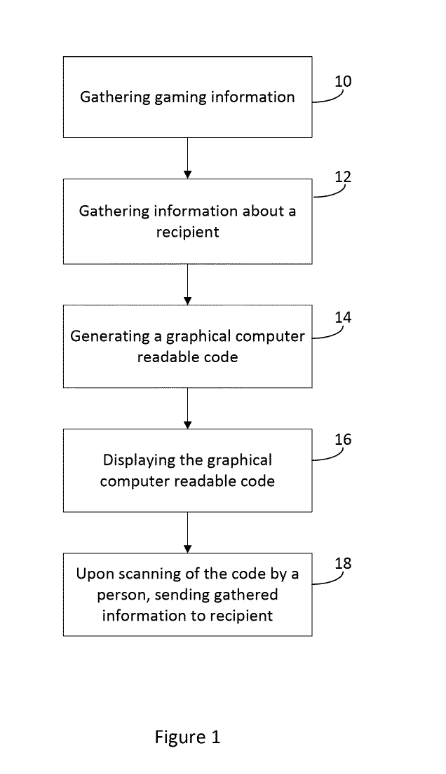

Graphical computer readable codes are useful to facilitate and enhance communication between parties implicated in a gaming environment. A simple embodiment, illustrated in FIG. 1, describes a method of using such a graphical computer readable code in a gaming environment in which gaming information are gathered (step 10) on the gaming device, as well as information about the recipient (i.e., recipient ID data) of the gaming information (step 12). A graphical computer readable code is generated (step 14), comprising or using the gathered gaming information and displayed (step 16), either on the screen of gaming device or printed on a ticket. When a person scans the code using a mobile device capable of scanning graphical computer readable code and connecting to the internet, the gathered gaming information is sent to the recipient for which gaming information has been gathered (step 18).

The gathered gaming information may concern the gaming device (ID code, software or hardware information, IP address if connected to the internet, etc.), the location where the gaming device is installed or its owner/manager (ID data, address, name(s) of owner(s)/manager(s), security level, etc.), the game played on the gaming device (title, type of game, value of a jackpot when offered, play ID, outcome of a play, etc.), gaming authorities, or a patron (ID data, credits, category of patron, security level, wins, losses, realisations, etc.). Examples of gathered gaming information include: (a) device identification information; (b) device status information; and (c) game status information. Information for identifying the gaming device, namely device identification information, and information about a status of the gaming device, namely device status information are also referred to herein as gaming device information.

Accordingly, the recipient may be a person, a role (which may be occupied by a plurality of persons, but is tied more to a certain function than a single person, such as location manager) or an entity (such as a sweepstake operator, or tribal or state game authorities for example). Examples of the recipient include: (a) gaming authorities; (b) a gaming facility operator or location manager: (c) a game operator; (d) a game manufacturer; and (e) a game player.

In certain circumstances, it is advisable to protect all or part of the gathered gaming information and make sure that third-parties could not, by scanning the barcode, gain access to the information. In such situations, the gathered gaming information may be encrypted before the barcode is generated. The means to decrypt the gaming information may be provided to the recipient in advance, by email or through the game operator or game manufacturer website, or may be embedded in the mobile application, using security levels to determine whether or not the person who scanned the code can decrypt and obtain the gaming information or not.

The communication using graphical computer readable codes is particularly useful having regard to three (3) types of relationship or gaming environment described in embodiments disclosed herein. Those types are: (1) sweepstakes; (2) device-status-centered communication, such as in redemption gaming, manufacturer- or operator-limited gaming, or device maintenance; and (3) enhanced gaming. However, a person skilled in the gaming art would be able to think about other relationships or communication needs in the gaming environment where these codes would also be useful.

In a plurality of embodiments in the present description, a mobile application may be provided to install on a mobile device, such as a smart phone, equipped with scanning equipment able to read graphical computer readable codes. Since the users may enter their User ID in the application, it allows them to identify themselves easily and rapidly to the different websites and devices implicated in the system, and provides different levels of access depending on security permissions. In certain embodiments, the application may also be used to obtain supplemental material associated with the game played or accessed. This supplemental material may be awards, such as trophies and titles, images, sounds, or text. In other embodiments, the mobile application may provide promotions or rebates for game play or other products.

### (1) Sweepstake Games

Sweepstake games are really popular in certain jurisdictions. Since they comprise awarding prizes for winning entries that are handed to players with or without purchasing a product, their conduct is different from the conduct of other types of games. Especially when the product sold is intangible, such as long-distance call minutes or gift cards, and the entry itself is also intangible.

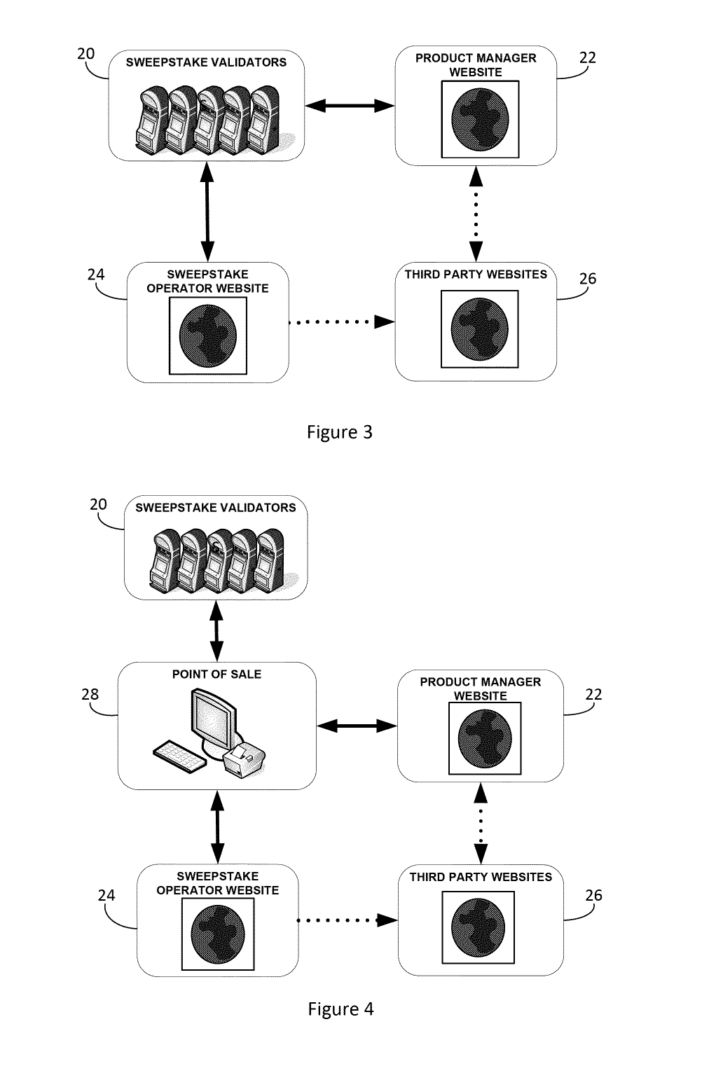

FIGS. 3 and 4 illustrate components of sweepstake embodiments when intangible or electronic entries are used.

In such an environment, electronic devices, namely sweepstake validators 20, are required to validate and reveal the outcome of the electronic entries. These sweepstake validators 20 may display or print the outcome in a simple manner—losing or winning with the associated prize—or through an entertaining reveal game. The sweepstake validator 20 may also be used to purchase the product if no dedicated point of sale device (POS) 28 is provided.

In a sweepstake environment, the sweepstake operator is responsible for organizing and managing the sweepstake games. For each sweepstake game, a population of a fixed number of entries is generated, based on a predetermined pay table, and among which there are winning and losing entries. In certain jurisdictions, at least one of: the number of entries; the maximum amount a winning entry may award to a participant; or the proportion of winning/losing entries, is regulated by authorities. The sweepstake operator maintains a sweepstake operator website 24 that the location managers contact/consult to inform the sweepstake operator of the status and evolution of the sweepstake game as played in their location, to be informed of the status and evolution of the sweepstake game as played in other locations, and to refill their sweepstake entries inventory when necessary.

The point of sale device (POS) 28 is used to manage the sale of the product and the distribution of sweepstake entries (both purchase and no-purchase entries). The POS 28 sends the sweepstake entries to sweepstake validators 20 where the player may reveal their outcome. Also, since all winning information is sent to the POS 28, it manages the awarding of prizes for winning entries and informs the sweepstake operator (via communicating with the sweepstake operator website 24) of the status and evolution of the current sweepstake game. Finally, the POS 28 generates alerts for technical troubleshooting and a plurality of management reports and statistics for legal and tax purposes.

Through the product manager website 22, the product manager is responsible for providing the product to the location manager, who in turn, is responsible for selling the product and distributing the sweepstake entries. The location manager must also make sure that patrons have access to a means for requesting no-purchase entries into the sweepstake games.

Even if not, per se, part of the sweepstake gaming environment, the service or merchandise provider offers a service or merchandise in exchange for the product when the product is intangible. For example, the telephone company that provides actual long-distance minutes in exchange for the proof of purchase of those minutes, as well as the merchant who accepts the gift certificates, are service or merchandise providers in these embodiments. In some embodiments, a single entity fulfills both roles of product manager and service or merchandise provider. These providers and other parties maintain third-party websites 26 to allow the use of the purchased product, or to publicise the sweepstake games and to follow their progress. These third-party websites 26 may add significantly to the patrons' experience. To fulfill these functions, the third-party websites 26, may have to receive information or input from the sweepstake operator website 24 and to share financial interests with the product manager using, in an embodiment, the product manager website 22.

The sweepstake embodiments herein described are merely illustrations of how the present methods and systems may be implemented. Other steps or means may be substituted for those provided in these descriptions, and some steps may not be essential for their good working.

In a first sweepstake embodiment, the product comprises gift certificates which may be purchased at a location owned or operated by the location manager, the sweepstake entries are distributed to the patrons as electronic pull-tabs, the location manager has at least one POS 28 in his location, and the sweepstake validators 20 are casino-like gaming cabinets to read the sweepstake entries and reveal their outcome in an entertaining manner.

### Activation by the Location Manager

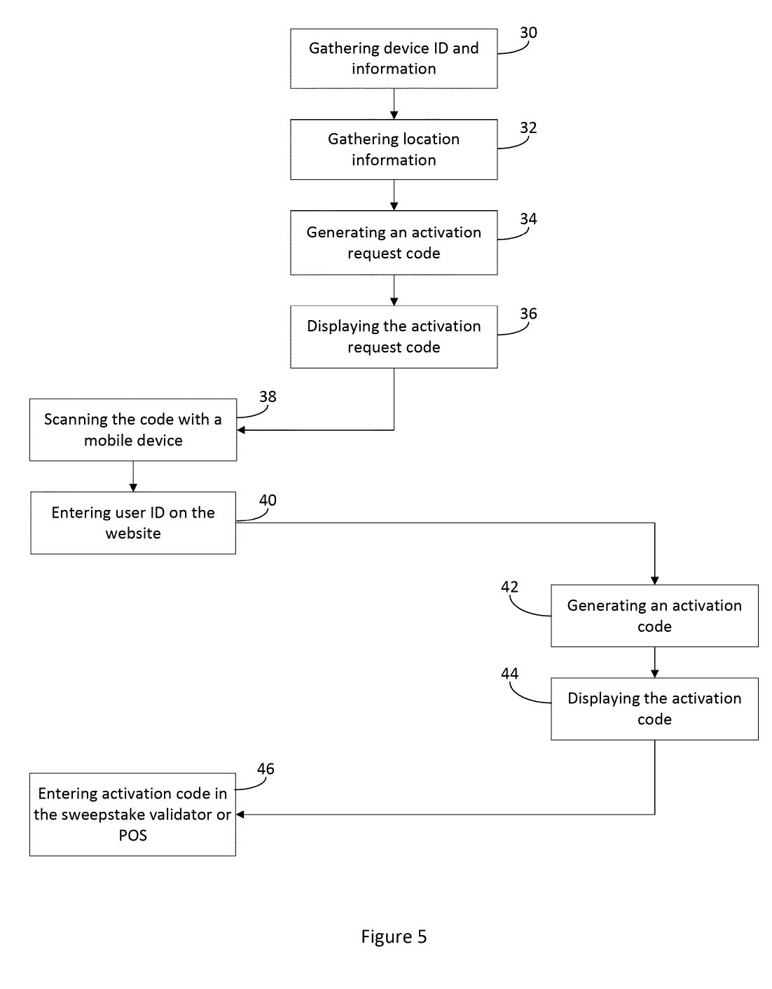

At first, when the POS 28 are installed, they must be activated. When turned on, the POS 28 verifies whether or not it has been activated. If the POS 28 needs to be activated, as described in FIG. 5, unique device identification codes, such as a serial code, an IP address if the device is connected to the internet, or any other information that identifies it in a unique way in the system, are gathered (step 30). It may also comprise information about the hardware of the device, the installed software version, as well as about the location manager or the location itself (step 32). In this embodiment, the gathered gaming information, is coded into a barcode to generate an activation request code (step 34), which is displayed on the screen of the POS 28 or may be printed on a ticket (step 36). Generating such a code facilitates the entry and limits the risk of clerical error; also the device can easily and automatically be identified and associated with the location where it will be used.

After scanning the barcode with a mobile device (step 38), the location manager is directed to the sweepstake operator website 24 and identifies themselves using their User ID (step 40)—if a sweepstake mobile application is installed on the mobile device used to scan the barcode, the application identifies the mobile device owner and thus, removes the need for this step. Since the barcode contains and communicates not only the sweepstake operator website address, but also an activation request code and device identification information, the system has everything it needs to generate an activation code (step 42), by displaying it on the screen (step 44), and sending it via email and any other direct communication means if such is available.

Once the location manager has entered the required activation code in the appropriate menu (step 46), the device (POS 28) is activated and ready to manage the product inventory and sweepstake entries, and the installed sweepstake validators 20.

If the location manager does not have any POS 28 in his location, all the steps described as being realised on or by the POS 28 would have been realised by or on a sweepstake validator 20. In such a case, each sweepstake validator 20 installed in a location is independent and manages its own product and sweepstake entries inventories. Accordingly, the location manager has to activate as many sweepstake validators 20 as he wants in his location.

### Product and Sweepstake Entries Inventories

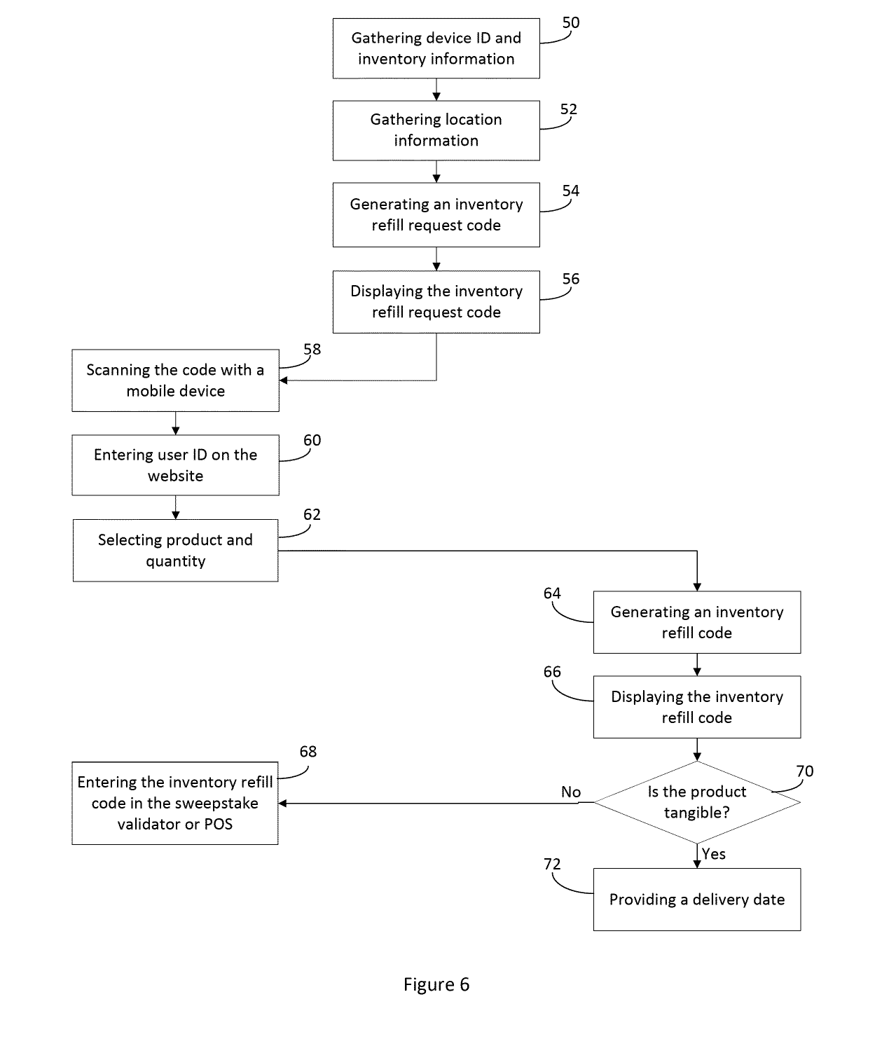

FIG. 6 describes the procedure to initially fill or to refill the product inventory, which are essentially the same. To ease the operations, the POS 28 has an embedded process to easily and quickly order more products and refill the product inventory.

The product inventory refill process is almost the same as the activation process, but this time, the location manager connects to the product manager website 22: after unique device identification information, as well as information about the current status of the product inventory (step 50), and about the location manager or the location itself (step 52), are gathered, an inventory refill request code (in the form of a barcode) is generated (step 54) and displayed on the screen of the POS 28 or printed on a ticket (step 56).

Once the inventory refill request code is scanned using a mobile device capable of scanning barcodes (step 58), the location manager is invited to identify himself on the product manager website 22 by entering his user ID (step 60), then, he selects the desired product among those offered and the quantity required (step 62). To complete the transaction, the product manager website 22 generates (step 64) and displays a product inventory refill code (step 66). The product inventory refill code may also be emailed to the location manager or directly sent to the POS 28 if a direct communication means, such as the internet, is available. If the product is intangible (verified at step 70), the location manager enters the product inventory refill code in the appropriate menu of the POS 28 (step 68) to update the product inventory, adding the acquired products; if the product comprises tangible merchandise (verified at step 70), a delivery date is set (step 72). The POS 28 is now ready to sell products and associate sweepstake entries to those sales.

If the location manager does not have any POS 28, the steps herein described would all have occurred on each sweepstake validator 20 installed in the location, when first installed and then when its product inventory triggers the “inventory low” alert, or whenever the location manager decides to check the inventory level.

Upon a product inventory refill request, the POS 28 (or the sweepstake validator 20 when no POS 28 is installed) also requests a sweepstake entries inventory refill to make sure that entries can be provided with all product purchases. As with the activation process, in the sweepstake entry inventory refill process, the location manager connects with the sweepstake operator website 24. After the location manager has identified themselves (or have been identified by the sweepstake mobile application), the process is essentially the same as for refilling the product inventory. Information about the product inventory refill transaction, such as the nature and quantity of purchased products, is communicated to the sweepstake operator, so the sweepstake entry inventory may be refilled compatibly with the product inventory refill. In the embodiments where one entity is both the sweepstake operator and the product manager, requesting a product inventory refill automatically results in a sweepstake entry inventory refill without any intervention from the location manager.

Since the POS 28 is a management tool unable to reveal the outcome of the Sweepstake entries, sweepstake validators 20 are provided to patrons. In this embodiment, the sweepstake validators 20 are devices resembling casino-like gaming machines. But they could also be computer terminals where the patrons may play a game resulting in revealing the outcomes and prize values of their entries. Regardless of the type of device, the sweepstake validators 20 must be activated and linked to the POS 28 before being available to patrons.

If the sweepstake validators 20 are provided by the sweepstake operator, they may bear, in the operator menu, barcodes comprising all the identification information necessary for activation and management. The location manager enters the identification information of each sweepstake validator 20 to activate in the appropriate menu on the POS 28. If more than one sweepstake validators 20 are available in the same location, these devices may be divided in groups, or banks, to facilitate their management.

Once the sweepstakes validators 20 are activated and linked to the POS 28, the location manager may begin selling products and distributing sweepstake entries for the enjoyment of their patrons.

Play of the Sweepstake without a POS

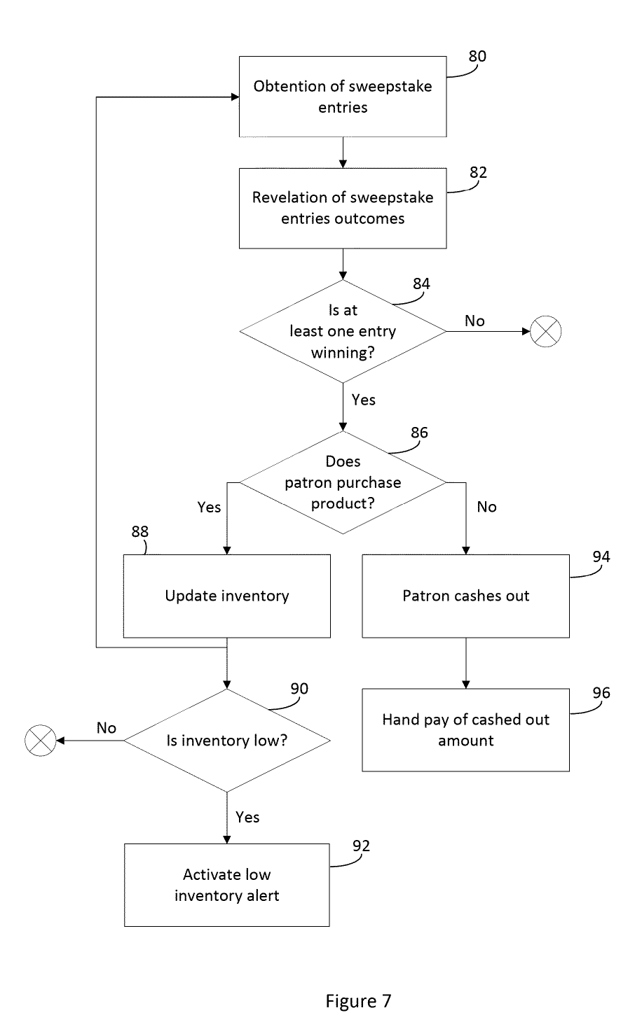

FIG. 7 describes how the sweepstake is played in the absence of a POS 28. When a patron operates the sweepstake validator 20 to purchase products, a purchase ticket, bearing all the information about the purchase, is printed. The purchase ticket is redeemed by the location manager against products, if tangible, or may be used by the patron on a third-party website if they are intangible. All the information necessary for the use of the products, such as third-party website address, appears on the purchase ticket. Regardless of the nature of the products, the information may be printed on the purchase ticket in a readable manner and as a graphical computer readable code.

When the purchase is completed, the patron obtains the number of sweepstake entries corresponding to the purchased products (step 80). To reveal the outcome of the sweepstake entries (step 82), the patron makes a choice, through the patron menu, to reveal the outcomes directly on the screen without any entertaining animation, or through the play of the entertaining reveal game. Regardless of the choice of the patron, when the outcome of all sweepstake entries is revealed, the total of all prizes awarded for winning sweepstake entries is added to the awards box. If at least one sweepstake entry is winning (step 84) and the amount appearing in the awards box is sufficient, the patron may decide to purchase more products (step 86) and receive new sweepstake entries. If so, the corresponding purchase ticket is printed and the purchase price is subtracted from the awards box. Upon making this purchase, the sweepstake entry inventory is updated (step 88) and its level is evaluated (step 90). If the inventory has reached a certain low level, the “inventory low” alert is activated (step 92), inviting the location manager to contact the sweepstake operator to refill their sweepstake entries inventory. When the patron cashes out (step 94) when all their entries have been revealed and they decided not to purchase any more products, the sweepstake validator 20 prints a sweepstake awards ticket bearing, usually both in a readable form and in graphical computer readable code, the amount left in the awards box for hand payment at the location manager cashier (step 96).

Play of the Sweepstake with a POS

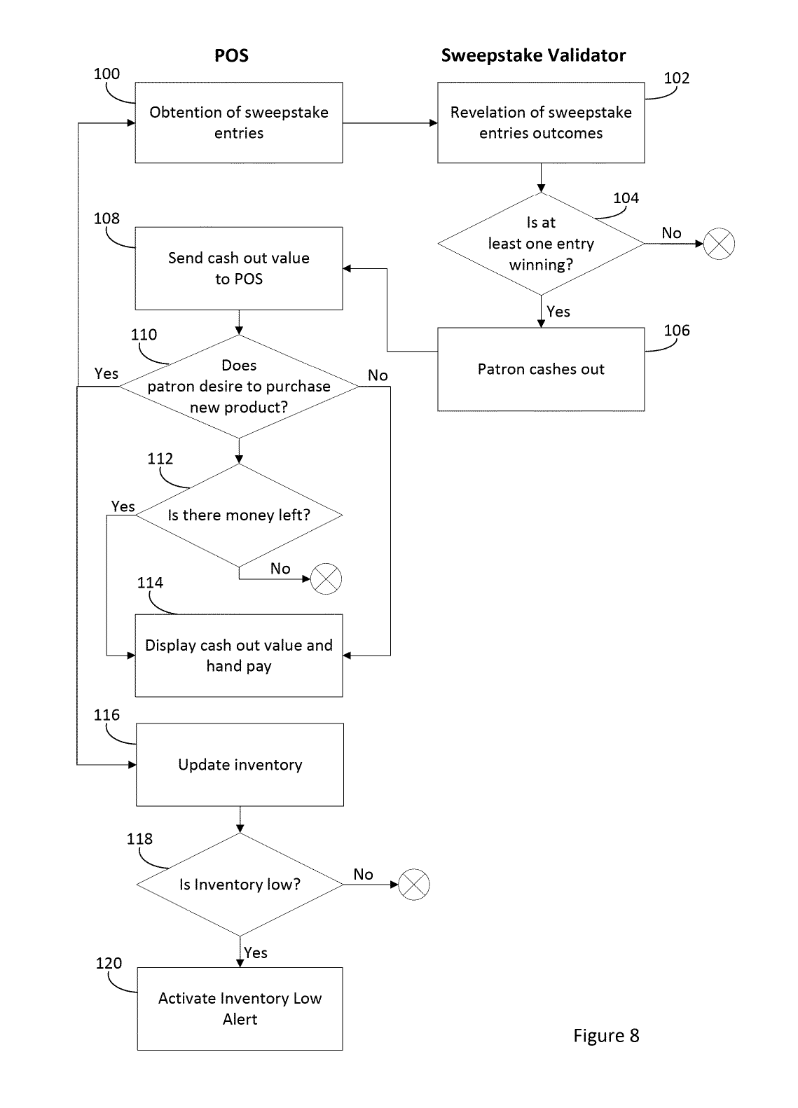

FIG. 8 describes an embodiment of the method wherein the location manager has a POS 28. In such a system, the steps that were realised on the sweepstake validators 20 are now divided between the POS 28 and the sweepstake validator 20, the POS 28 being responsible for all product transactions and for paying the winning players.

To purchase products, the patrons visit the location manager cashier who logs these purchases on the POS 28. In response, the POS 28 provides a purchase ticket bearing all the information about the purchase, and which may be redeemed by the location manager against tangible products, or may be used by the patron on a third-party website if the products are intangible. This redemption of the purchase tickets is the same as explained for the sweepstake play without a POS 28.

When the purchase is completed, the corresponding number of sweepstake entries is provided to the patron by sending them from the POS 28 to a sweepstake validator 20 (step 100).

Regardless of the method of revealing the outcome of the sweepstake entries (step 102) (directly or through an entertaining reveal animation), and if at least one of the entries is winning (step 104), the total of all prizes awarded for winning sweepstake entries is added to the awards box. The patron cashes out (step 106) and the cash out information, including the amount appearing in the awards box and the sweepstake validator ID, is sent to the POS 28 (step 108). The patron may then decide to purchase new products or not (step 110). If the player decides not to purchase new products, the cash out value is displayed and the cashier hand pays the patron (step 114).

On the other hand, if the player decides to purchase new products, a new purchase ticket reflecting this new purchase is provided for the nature and quantity of purchased products. If there is still money left in the award box (step 112), the remaining amount is displayed and the cashier hands pay the patron (step 114). At the same time, the product inventory is updated (step 116) to reflect the purchase and the inventory level is verified to determine whether or not it is low (step 118). If it is the case, the low inventory alert is activated (step 120) and the location manager is thus informed that they should refill their product inventory.

### No-Purchase Entries

Since a sweepstake must also allow participants to enter without having to make any purchase, a means to get free entry has to be provided. According to an embodiment, there is provided a method to distribute no-purchase entries to patrons.

There are many ways a participant may request a no-purchase entry. The easiest way is to request a no-purchase entry ticket from the location manager. Sometimes, the sweepstake operator provides a plurality of such tickets to each location manager who can distribute them to patrons. The no-purchase entry ticket bears an entry code the patron enters into a sweepstake validator 20, which results in distributing a sweepstake entry coming from the population of entries of the current sweepstake game. The sweepstake validator 20 reveals the outcome of the entry, by printing or displaying the outcome or through an entertaining reveal game.

No-purchase entries may also be obtained through the sweepstake validators 20. Usually, a no-purchase entry request barcode is displayed in the patron menu. This barcode, when scanned with a mobile device, opens the sweepstake operator website 24 which gives the instructions and the means to request such an entry.

Certain sweepstake operators may require the patron to send a written request, by mail, with a pre-addressed envelope to get a no-purchase entry. Usually, their website provides a form to fill and then print before sending, or it can be printed by the location manager through the POS 28. If that is the case, upon reception of the request, the sweepstake operator returns a no-purchase entry ticket bearing a no-purchase entry code to enter in the sweepstake validator 20, as done with tickets distributed by the location manager. Some sweepstake operators prefer that the request is sent by email; they will send the requested no-purchase entry code by email also. Others choose to provide the no-purchase entry immediately, either by displaying the no-purchase entry code on the screen of the device used to scan the barcode, sending it by email to the patron's device, or sending it to the POS 28 the request came from.

In any case, to play a no-purchase entry, the patron gives the no-purchase entry code, found on the no-purchase entry ticket or given by the sweepstake operator digitally, to the location manager for entry into the POS 28, or they enter it themselves into the appropriate window in the patron menu on a sweepstake validator 20. Once the no-purchase entry code is validated and confirmed as a valid no-purchase entry code, the no-purchase entry is provided and the patron may decide how to reveal its outcome, as done with the entries distributed with purchased products.

The no-purchase entries are part of the same sweepstake game and come from the same sweepstake entry set as the purchase entries distributed with purchased products; only their distribution conditions are different.

### Maintenance and Reports

Each sweepstake validator 20 and the POS 28 are equipped with an alert system allowing the location manager to follow the product inventory and the sweepstake entries inventory. For example, after each product purchase is completed, both the product inventory and the sweepstake entries inventory are updated and compared to low inventory threshold values. If at least one of the inventories is equal or inferior to its corresponding low inventory threshold value, an alert is activated to inform the location manager of this fact. It is then easy to request an inventory refill.

When a POS 28 is present, and since all sweepstake validators 20 are linked to the POS 28, the inventory management is usually done in full on the POS 28. It has the advantage of allowing the location manager to keep up with all that can happen without having to check on each and every sweepstake validators 20 periodically. Moreover, since the product inventory is managed centrally it is better balanced and is not influenced by the popularity of a better situated sweepstake validator 20 compared to other sweepstake validators 20 in the same location.

Sweepstakes being a legal game of chance, authorities may require reports on the conduct of the sweepstake, globally or for each location. Accordingly, the system must provide the information necessary to file those reports. The POS 28 maintains a log of all operations that have occurred in each sweepstake validator 20 (such as a list of all transactions, including the transactions that have failed), and print or provide in a file format all the information about the product sales, the number of distributed sweepstake entries, the percentage of winning and losing entries, as well as the prizes awarded, and thus globally or by sweepstake validator 20. Also, the POS 28 maintains a log on technical issues of the sweepstake validators 20 for troubleshooting and to reassure authorities on the stability and fairness of the system.

In the absence of a POS 28, each sweepstake validator 20 is programmed to maintain a log of all its operations, and to print or to provide in a file format all the information about the product sales, the number of distributed sweepstake entries, the percentage of winning and losing entries, as well as the prizes awarded. Also, each sweepstake validator 20 maintains a log on technical issues for troubleshooting and to reassure authorities on the stability and fairness of the system.

To facilitate the maintenance of the sweepstake validators 20 and the generation of reports, a barcode is displayed in the help menu or in an operator menu to identify each machine (POS 28 and sweepstake validators 20) and communicate the necessary information. That way, there is no need to print the reports or consult different menus to have a clear picture of what is going on with the device. In an embodiment, to access the information, the sweepstake mobile application is required. In this situation, if a patron scans the code, since they do not have the sweepstake mobile application, or at least not the required permissions, they are taken to the sweepstake website to get information about the current sweepstake and possibly learn whether or not jackpots have been won.

### (2) Device-Status-Centered Communication

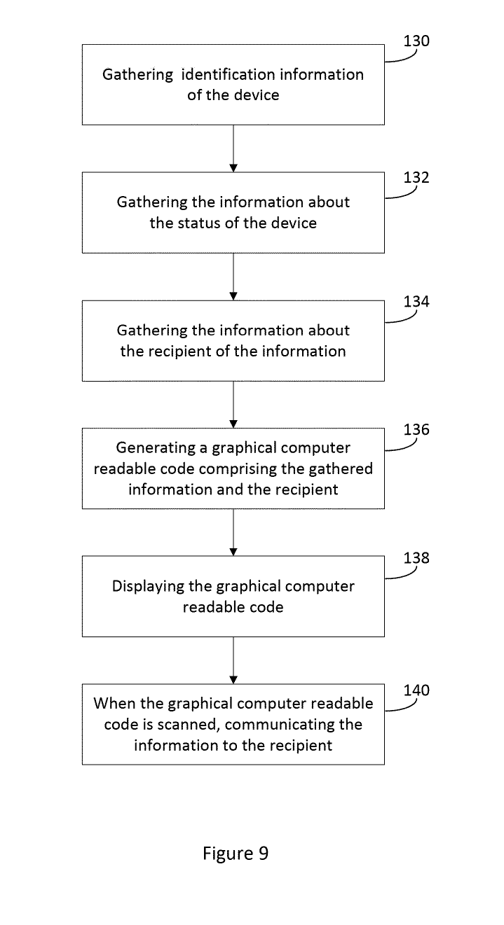

Regardless of the type of game, FIG. 9 describes embodiments of the method of using a graphical computer readable code in a gaming environment when the status of the device has an impact on the nature or function of the generated code. An example of such an embodiment is a gaming environment wherein, in certain jurisdictions or according to the business model, the gaming devices are activated for a certain time, cash-in amount (money played by the patrons) or number of plays; once the limit is reached, the gaming device deactivates itself automatically and needs a reactivation code or key to be reactivated.

In such an embodiment, the identification of a gaming device is gathered (step 130). This identification information may be a serial code, an IP address if the device is connected on the Internet, or any other information that identifies the device in a unique way in the system. It may also comprises information about hardware of the device, the installed software version, as well as about the location manager or the location itself

The status of the device is also gathered (step 132). Depending on the reason why the graphical computer readable code will be generated, the nature of the status gathered will vary. For example, if the code is displayed in the operator menu and is used in an activation process, the status information gathered will be whether the device is activated or not and may also comprise information about levels of inventories or any other information that may be useful in the activation process (as in the following redemption gaming example). On the other hand, the graphical computer readable code may also be displayed in a publicly available page and be used to identify the device to the gaming authorities. In such a case, the status would comprise information useful to verify whether or not the device complies with rules in this jurisdiction.

The reason a graphical computer readable is generated also determines in part the recipient for which it is generated. Accordingly, information about this recipient are also gathered (step 134). Examples of recipients are the manufacturer or game operator in an activation process, and a patron to get no-purchase entry in a sweepstake or to gain access to their awards in a particular game. The recipient information may comprise their ID, name, security level, website address, email address, and any other information useful to communicate the information in a meaningful and useful way.

Once all the pertinent information has been gathered, the graphical computer readable code is generated (step 136) and displayed (step 138), either on the screen of the gaming device, or printed on a ticket. When a person scans the graphical computer readable code, the gaming information is communicated to the recipient (step 140), either by access to their website, email or any other communication means.

In an embodiment, the graphical computer readable code also comprises the date and time it was generated, allowing the different actors in the system to accept or refuse a code according to the date and time it was generated. For example, if a barcode is printed on an award ticket, the sweepstake operator may decide to refuse to redeem it if the ticket is older than a year.

The gaming information may be gathered and the graphical computer readable code generated and displayed upon request only, for example on accessing a specific menu, such as an operator or a player menu. This step ensures that the code always contains the most up-to-date status and recipient information. But the graphical readable code may also be generated once, at the gaming device activation for example, and displayed permanently or on request. This would be the case for a graphical readable code allowing patron to visit a website about the manufacturer or the actual game for example.

The redemption gaming environment is an example of an embodiment in a jurisdiction where gaming device activity may be limited by the manufacturer or gaming operator. In such an embodiment, circumstances in which graphical computer readable codes are useful comprise, but are not limited to: activating the redemption gaming devices, providing statistical and status information about a gaming device to the gaming operator or manufacturer and the location manager, providing license, statistical and status information about a gaming device to jurisdictional and licensing authorities.

In an embodiment of redemption gaming, a game manufacturer, herein identified as redemption gaming provider, limits the activation of the gaming device to a predetermined number of plays. Once the plays are all used up, the gaming device stops working. To avoid down time, the location manager may activate a supplemental number of plays if the conditions to do so are met—usually paying the manufacturer the percentage of gaming revenues due to them according to their contract. When a new redemption gaming device is installed in the location, the location manager must activate it. When turned on, the redemption gaming device provides the location manager with an activation request code, unique identification codes, through a graphical computer readable code, so the device can be identified and associated with the location where it will be used.

Each time the location manager accesses the operator menu on the gaming device and requests a code to communicate, usually to reactivate the gaming device or to refill the plays, cash-in value or time period so the gaming device does not deactivate, the current status of the machine is evaluated to determine the kind of activation code that will be generated: first activation request code, reactivation request code, or a refill request code. In a case where the limit set by the manufacturer would be the number of plays, a refill request code may include the number of plays played since the last request (activation, reactivation or refill) and thus inform the manufacturer of the amount the location manager owes them and should pay to get new plays.

Regardless on the type of code, after scanning the graphical computer readable code with a mobile device, the location manager is directed to the mobile-version of the redemption gaming provider website and identifies themselves using their User ID. Since the barcode contains and communicates not only the redemption gaming provider website address but also the device identification and device status information, as well as a request code, the system has everything it needs to provide the appropriate activation code, by displaying it on the screen, and sending it via email or any other direct communication means if such is available.

But a manufacturer- or operator-limited gaming environment is not the only gaming environment where the status of the gaming device—money played, or number of plays, for example—may be important or useful. Errors or malfunctions that occur during the play, with or without stopping the game, produce error messages that may also gathered to produce graphical computer readable codes. By scanning the generated code using a mobile device equipped with the appropriate mobile application, the manufacturer may give instructions on how to solve the error or malfunction.

Another example, as seen earlier, may be communication with gaming authorities. In that case, the status information may be as simple as the gaming device license number, or as complex as comprising logs of activity that has occurred on the device during a predetermined period. It may also comprise reports derived from the information contained in those logs. Accordingly, the status information may comprise the reports and statistics required by the jurisdiction where the device is operated. If a plurality of different reports should be provided to different authorities, different graphical computer readable codes, always up-to-date may be displayed in a menu available to the gaming authorities' employee.

### (3) Enhanced Gaming

In an embodiment, enhanced gaming is provided to patrons. There are different manners in which enhanced gaming may be offered: free plays, advantage in the game, trophies, rebates and promotions, as well as supplemental materials about the games patrons may enjoy at home.

In a first embodiment of enhanced gaming, the location manager may offer free plays in different games in the location. These free plays may be distributed through the gaming devices or through a dedicated gaming device whose only function would be to provide free plays and promotions. Regardless on the type of gaming device, the patron would be able, through a patron menu, to access free plays for the desired game or promotions. Upon opening the patron menu, game information (game currently installed in the gaming device, games offered in the casino and available for free plays, current promotions, etc.), gaming device information (device ID), as well as date and time information, would be gathered. Graphical computer readable codes are generated and displayed to allow the patron to choose which game they desire to try or what promotions they want to enjoy. By scanning the code, the patron requests a coupon which they will redeem against the free plays or the promotions. The coupon may be displayed on the patron's mobile device or be sent by email or sms. This coupon contains all the information necessary to activate the free plays or promotions, either by entering a passcode in the patron menu of the gaming device or by scanning a barcode when a camera is provided on the gaming device.

In another embodiment, enhanced gaming is provided through advantage in the game, such as free credits or a better bonus. In such an embodiment, the gaming information comprises an event occurring in the game which qualifies the patron for an advantage, patron ID, level of play, etc.; this event may be a particular outcome in the game or a random trigger not linked to an outcome in the game. Upon occurrence of such an event, the nature of the event, as well as gaming device information are gathered. Then, a graphical computer readable code is generated and displayed on the gaming device. Scanning the code allows the patron to receive a coupon (via a website, by email or sms), which when redeemed give access to free credits or a particular bonus. Scanning the code has the advantage of being able to vary the probability to obtain certain coupons in comparison to others depending on the date or time, on the frequency of wins in the last few hours or days, the level of play of the patron or the patron ID. Accordingly, the manufacturer or game operator may decide to give bigger prizes in a location down time to incite patrons to play when the gaming devices are less occupied, or they can favor patrons who play at higher bet levels.

A further embodiment provides trophies and supplemental material associated with the game. Upon occurrence of a particular event in the game, the patron qualifies for a trophy, such as those given in console games, or supplemental material, such as graphics, sounds (such as ringtones), videos, or any other material the manufacturer may offer in association with a game. Upon occurrence of the event, the nature of the event, the patron ID, time and date and any other pertinent information is gathered. A graphical computer readable code is generated and displayed on the gaming device. By scanning the graphical computer readable code, the patron sends a request to the manufacturer and the trophy or supplemental material is associated with the patron ID. The trophy or supplemental material can be accessed immediately or at a later time, and remains associated with the patron ID for continued enjoyment.

It should be noted that the embodiments described herein can be carried out as a method, or can be materialised in a system, a computer readable medium, or a processor-readable memory.

The embodiments described above are intended to be exemplary only. The scope of the embodiments is therefore intended to be limited solely by the scope of the appended claims.

1. A method of using a graphical computer readable code in a gaming environment comprising a gaming device, the method comprising:
gathering, on the gaming device, gaming information;
gathering, on the gaming device, ID data about a recipient, namely recipient ID data, to whom the gaming information is intended;
generating, on the gaming device, the graphical computer readable code, such that it comprises the gathered gaming information;
displaying, on the gaming device, the graphical computer readable code; and
in response to a scanning of the graphical computer readable code using a code scanning device, communicating the gathered gaming information to the recipient using the recipient ID data.

2. The method of claim 1, further comprising:
gathering, on the gaming device, date and time information; and wherein the graphical computer readable code comprises the date and time information.

3. The method of claim 1, wherein the gathered gaming information comprises at least one of: (a) device identification information; (b) device status information; and (c) game status information.

4. The method of claim 1, wherein the recipient comprises at least one of (a) gaming authorities; (b) a gaming facility operator; (c) a game operator; (d) a game manufacturer; and (e) a game player.

5. The method of claim 1, wherein the graphical computer readable code comprises a one- or two-dimension barcode.

6. A method of using a graphical readable code in a gaming environment comprising a gaming device, the method comprising:
gathering, on the gaming device, gaming device information comprising: information for identifying the gaming device, namely device identification information; and information about a status of the gaming device, namely device status information;
gathering, on the gaming device, ID data about a recipient, namely recipient ID data, to whom the gaming device information is intended;
generating, on the gaming device, a graphical computer readable code comprising the gaming device information and the recipient ID data;
displaying, on the gaming device, the graphical computer readable code; and
in response to a scanning of the graphical computer readable code using a code scanning device, communicating the gaming device information to the recipient using the recipient ID data.

7. The method of claim 6, wherein the steps of gathering the gaming device information, gathering ID data about the recipient, generating the graphical computer readable code and displaying the graphical computer readable code are realised only upon request.

8. The method of claim 6, further comprising:
gathering, on the gaming device, date and time information; and wherein the graphical computer readable code comprises the date and time information.

9. The method of claim 6, wherein the recipient comprises at least one of (a) gaming authorities; (b) a gaming facility operator; (c) a game operator; (d) a game manufacturer; and (e) a game player.

10. The method of claim 6, wherein the graphical readable code comprises a one- or two-dimension barcode.

11. A method of using a graphical readable code in a gaming environment comprising a gaming device, the method comprising:
gathering, on the gaming device, game status information;
gathering, on the gaming device, ID data about a recipient, namely recipient ID data, to whom the game status information is intended;
generating, on the gaming device, a graphical computer readable code comprising the game status information and the recipient ID data;
displaying, on the gaming device, the graphical computer readable code; and
in response to a scanning of the graphical computer readable code using a code scanning device, communicating the game status information to the recipient using the recipient ID data.

12. The method of claim 11, wherein the steps of gathering the game status information, gathering ID data about the recipient, generating the graphical computer readable code and displaying the graphical computer readable code are realised only upon request.

13. The method of claim 11, further comprising:
gathering, on the gaming device, date and time information; and wherein the graphical computer readable code comprises the date and time information.

14. The method of claim 11, wherein the recipient comprises at least one of (a) gaming authorities; (b) a gaming facility operator; (c) a game operator; (d) a game manufacturer; and (e) a game player.

15. The method of claim 11, wherein the graphical readable code comprises one- or two-dimension barcode.
